(19) United States
(12) Patent Application Publication
(10) Pub. No.: US 2015/0370547 A1
(43) Pub. Date: Dec. 24, 2015

(54) PROGRAM EDITING DEVICE, PROGRAM EDITING METHOD AND PROGRAM EDITING PROGRAM

(71) Applicant: MITSUBISHI ELECTRIC CORPORATION, Chiyoda-ku, Tokyo (JP)

(72) Inventor: Akihiro MIURA, Tokyo (JP)

(73) Assignee: Mitsubishi Electric Corporation, Chiyoda-ku, Tokyo (JP)

(21) Appl. No.: 14/765,268

(22) PCT Filed: Apr. 8, 2013
(86) PCT No.: PCT/JP13/60589

§ 371 Date: Jul. 31, 2015

(51) Int. Cl. G06F 9/45; G06F 9/44

(52) U.S. Cl. CPC G06F 8/447; G06F 8/34

(57) ABSTRACT

A command code extraction part extracts, from among a plurality of command codes included in an instrument control program to be executed by a CPU unit and an input/output unit, a command code that is the same as an extraction target code indicated in an extraction target code list, as an extracted code. A sub-control program creation part creates, as a sub-control program to be executed by the input/output unit, a program including the extracted code that has been extracted. A main control program creation part creates, as a main control program to be executed by the CPU unit, a program which is obtained by removing from the instrument control program, the extracted code that has been extracted.

### TECHNICAL FIELD

The present invention relates to a program editing device, program editing method, and program editing program for editing, for example, a control program.

### BACKGROUND ART

In a conventional FA (Factory Automation) system, a control system is built by combining a CPU (Central Processing Unit) unit, an input/output unit, and the like, and a manufacturing device such as a motor or sensor is controlled by the control system.

The CPU unit performs an arithmetic processing described in a control program (for example, a ladder program) based on an input signal supplied from the manufacturing device to the input/output unit. The CPU unit transmits an output signal based on an arithmetic operation result to the manufacturing device, thereby controlling the manufacturing device.

In recent years, an input/output unit imparted with an arithmetic processing function has been employed widely aiming at reducing the load to the CPU unit and speed-of up an input/output to the manufacturing device.

Accordingly, part of the control program executed by the CPU unit can be executed by the input/output unit. Namely, the input/output unit can control an input/output to and from the manufacturing device without using the CPU unit.

The user, however, needs to manually extract that part of the control program which is to be executed by the input/output unit, and create a control program for the input/output unit from the extracted part of the control program. This increases the user workload.

As a prior art, a method is available that divides a control program into controller programs for controllers such as a programmable controller and a robot controller, and creates controller program modules for divisional control programs, respectively (see Patent Literature 1).

This method cannot extract part of the control program automatically and create a control program for the input/output unit.

Also, this method needs to create the control program by considering the controllers, and requires a programming technique for creating the control program.

### CITATION LIST

### Patent Literature

Patent Literature 1: JP 09-171405

### SUMMARY OF INVENTION

### Technical Problem

It is, for example, an object of the present invention to be able to extract a command code that can be executed by a second execution part (for example, an input/output unit), from among command codes included in a target program (for example, a control program), and create a second program to be executed by the second execution part.

### Solution to Problem

A program editing device according to the present invention includes:

an extraction target code storage part to store, among a plurality of command codes included in a target program to be executed by a first execution part and a second execution part, a command code to be executed by the second execution part, as an extraction target code;

a command code extraction part to extract, from among the plurality of command codes included in the target program, a command code that is the same as the extraction target code stored in the extraction target code storage part, as an extracted code;

a second program creating part to create, as a second program to be executed by the second execution part, a program including the extracted code extracted by the command code extraction part; and

a first program creating part to create, as a first program to be executed by the first execution part, a program which is obtained by removing from the target program, the extracted code extracted by the command code extracting part.

### Advantageous Effects of Invention

According to the present invention, for example, a command code that can be executed by a second execution part (for example, an input/output unit) can be extracted from among command codes included in a target program (for example, a control program), and a second program to be executed by the second execution part can be created.

### BRIEF DESCRIPTION OF DRAWINGS

FIG. 1 is a diagram illustrating a relation between a program editing device 100 and an instrument control device 200 according to Embodiment 1.

FIG. 2 is a functional configuration diagram of the program editing device 100 according to Embodiment 1.

FIG. 3 is a flowchart illustrating a program editing process of the program editing device 100 according to Embodiment 1.

FIG. 4 is a diagram illustrating an example of an instrument control program 210 according to Embodiment 1.

FIG. 5 is a diagram illustrating an example of an extraction target code list 191 according to Embodiment 1.

FIG. 6 is a diagram illustrating an example of an extracted code list 192 according to Embodiment 1.

FIG. 7 is a diagram illustrating an example of a sub-control program 212 according to Embodiment 1.

FIG. 8 is a diagram illustrating an example of a main control program 211 according to Embodiment 1.

FIG. 9 is a diagram illustrating an example of the main control program 211 according to Embodiment 1.

FIG. 10 is a diagram illustrating an example of hardware resources of the program editing device 100 according to Embodiment 1.

FIG. 11 is a functional configuration diagram of a program editing device 100 according to Embodiment 2.

FIG. 12 is a flowchart illustrating a program editing process of the program editing device 100 according to Embodiment 2.

FIG. 13 is a diagram illustrating an example of a sub-control parameter list 193 according to Embodiment 2.

FIG. 14 is a diagram illustrating an example of a sub-control parameter edit window 310 according to Embodiment 1.

FIG. 15 is a functional configuration diagram of a program editing device 100 according to Embodiment 3.

FIG. 16 is a flowchart illustrating the program editing process of the program editing device 100 according to Embodiment 3.

FIG. 17 is a diagram illustrating an example of a sub-control parameter edit window 310 according to Embodiment 3.

FIG. 18 is a functional configuration diagram of a program editing device 100 according to Embodiment 4.

FIG. 19 is a flowchart illustrating a program editing process of the program editing device 100 according to Embodiment 4.

FIG. 20 is a flowchart illustrating an example of a division code extracting process (S130) according to Embodiment 4.

FIG. 21 is a diagram illustrating a practical example of a command code dividing process (S133) according to Embodiment 4.

FIG. 22 is a functional configuration diagram of a program editing device 100 according to Embodiment 5.

FIG. 23 is a diagram illustrating an example of an extracting condition window 320 according to Embodiment 5.

FIG. 24 is a diagram illustrating an example of a label name correspondence table 329 according to Embodiment 5.

FIG. 25 is a diagram illustrating an example of an instrument control program 210 according to Embodiment 5.

FIG. 26 is a functional configuration diagram of a program editing device 100 according to Embodiment 6.

FIG. 27 is a flowchart illustrating a program editing process of the program editing device 100 according to Embodiment 6.

FIG. 28 is a flowchart illustrating a sub-control program editing process (S117) according to Embodiment 6.

FIG. 29 is a diagram illustrating a practical example of a detection result display process (S117-3) according to Embodiment 6.

### DESCRIPTION OF EMBODIMENTS

### Embodiment 1

An embodiment will be described in which a command code that can be executed by a second execution part (for example, an input/output unit) is extracted from among command codes included in a target program (for example, a control program), and a second program to be executed by the second execution part is created.

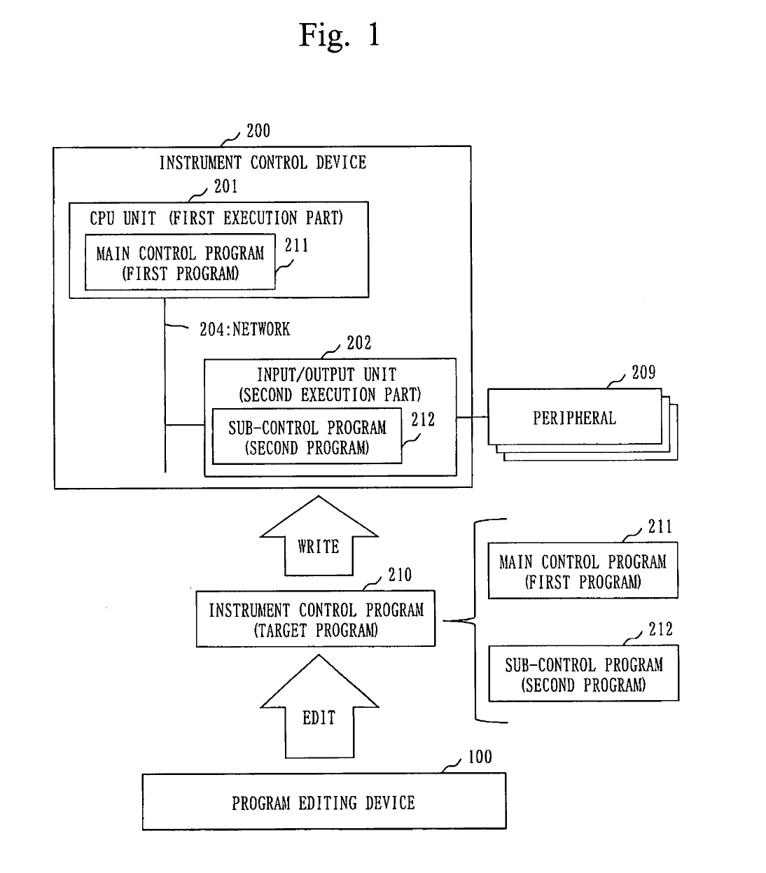

FIG. 1 is a diagram illustrating a relation between a program editing device 100 and an instrument control device 200 according to Embodiment 1.

The relation between the program editing device 100 and the instrument control device 200 according to Embodiment 1 will be described with reference to FIG. 1.

The instrument control device 200 controls peripherals 209 such as a sensor or motor.

For example, the instrument control device 200 is employed in an FA (Factory Automation) system.

The instrument control device 200 includes a CPU unit 201 (CPU: Central Processing Unit) and an input/output unit 202.

The CPU unit 201 (an example of a first execution part) is connected to the input/output unit 202 via a network 204 and controls the input/output unit 202 and the peripherals 209 connected to the input/output unit 202.

The CPU unit 201 has an arithmetic operating function (for example, an arithmetic operation circuit) for executing programs, and executes an instrument control program 210 (excluding a portion to be executed by the input/output unit 202) that serves to control the peripherals 209.

An example of the CPU unit 201 is a programmable controller.

The input/output unit 202 (an example of a second execution part) is connected to the peripherals 209 and supplies/receives a signal to/from the peripherals 209. For example, the input/output unit 202 receives an output signal outputted from the peripherals 209, and supplies a control signal for controlling the peripherals 209 to the peripherals 209.

The input/output unit 202 also has an arithmetic operating function, as the CPU unit 201 does, and executes part of the instrument control program 210.

The instrument control program 210 is a program for controlling the peripherals 209.

For example, the instrument control program 210 includes one or more statements for processing an output signal (for example, a signal representing a measurement value measured by the sensor) from the peripherals 209 and for generating the control signal (for example, a signal for starting or stopping the motor) based on the processing result.

The instrument control program 210 can be either a source program described in a programming language such as a ladder language or C language, or an object program described in a machine language.

The program editing device 100 is a computer that creates a main control program 211 (an example of the first program) and a sub-control program 212 (an example of the second program) by editing the instrument control program 210.

The main control program 211 is a program portion executed by the CPU unit 201, of the instrument control program 210.

The sub-control program 212 is a program portion executed by the input/output unit 202, of the instrument control program 210.

The program editing device 100 will be described hereinafter in detail.

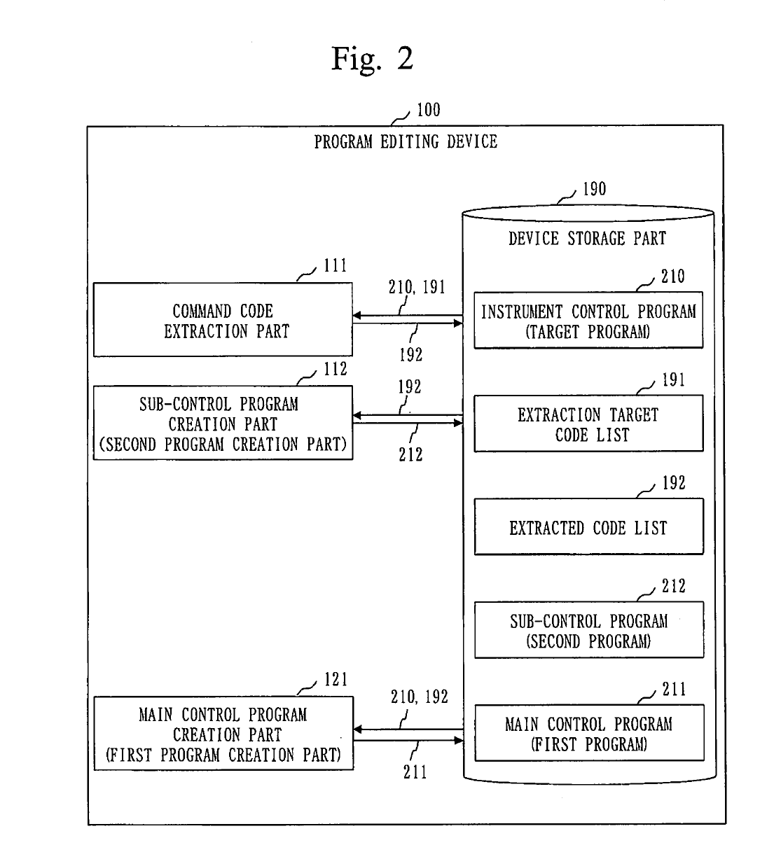

FIG. 2 is a functional configuration diagram of the program editing device 100 according to Embodiment 1.

The functional configuration of the program editing device 100 according to Embodiment 1 will be described with reference to FIG. 2.

The program editing device 100 includes a command code extraction part 111, a sub-control program creation part 112 (an example of a second program creating part), and a main control program creation part 121 (an example of a first program creating part).

The command code extraction part 111 extracts, from among the command codes included in the instrument control program 210 (an example of a target program), a command code which is the same as an extraction target code indicated in an extraction target code list 191, and creates an extracted code list 192.

The extraction target code list 191 indicates a listing of command codes (extraction target codes) that can be executed by the input/output unit 202.

The extracted code list 192 indicates a listing of command codes (to be referred to as extracted codes hereinafter) extracted from the instrument control program 210.

The sub-control program creation part 112 creates the sub-control program 212 (an example of the second program) including the extracted codes indicated in the extracted code list 192.

The main control program creation part 121 creates the main control program 211 (an example of the first program) by removing the extracted codes indicated in the extracted code list 192 from the instrument control program 210.

A device storage part 190 stores data to be used by the program editing device 100.

For example, the device storage part 190 stores the instrument control program 210, the extraction target code list 191, the extracted code list 192, the sub-control program 212, and the main control program 211.

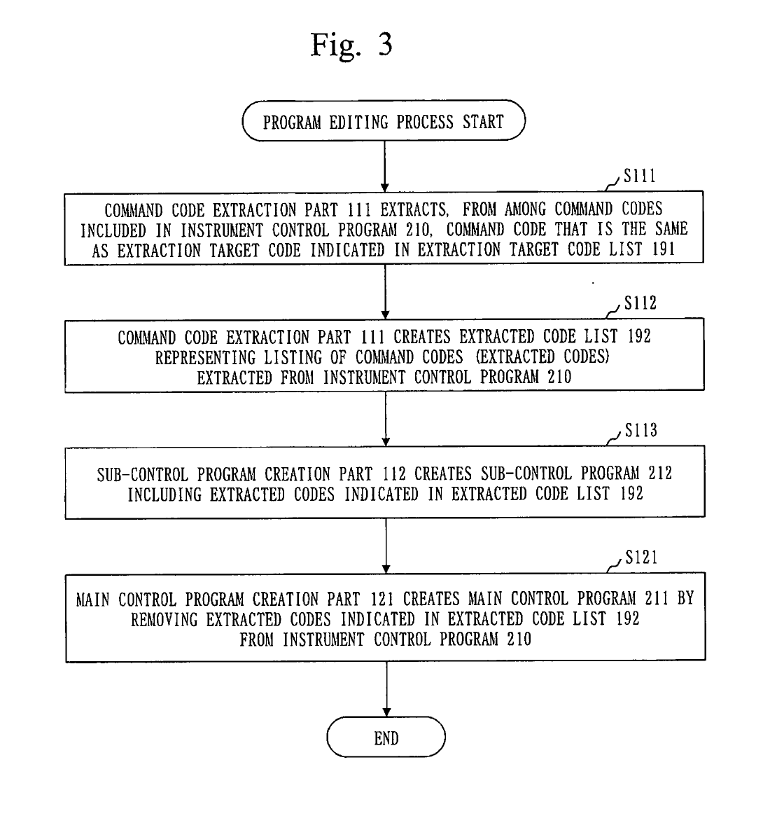

FIG. 3 is a flowchart illustrating a program editing process of the program editing device 100 according to Embodiment 1.

The program editing process of the program editing device 100 according to Embodiment 1 will be described with reference to FIG. 3.

In S111, the command code extraction part 111 extracts, from among the command codes included in the instrument control program 210, a command code that is the same as the extraction target code indicated in the extraction target code list 191.

A command code that is the same may be a command code which is the same completely, including its variable value, a command code having a different variable value but having the same code format, or a command code which is the same regarding the type of command or the type of arithmetic operation.

After S111, the process proceeds to S112.

In S112, the command code extraction part 111 creates the extracted code list 192 which is a listing of the command codes (extracted codes) extracted from the instrument control program 210.

The extracted code list 192 indicates the listing of the extracted codes as well as extracting portion identifiers each identifying, for each extracted code, the extracting portion of the extracted code.

After S112, the process proceeds to S113.

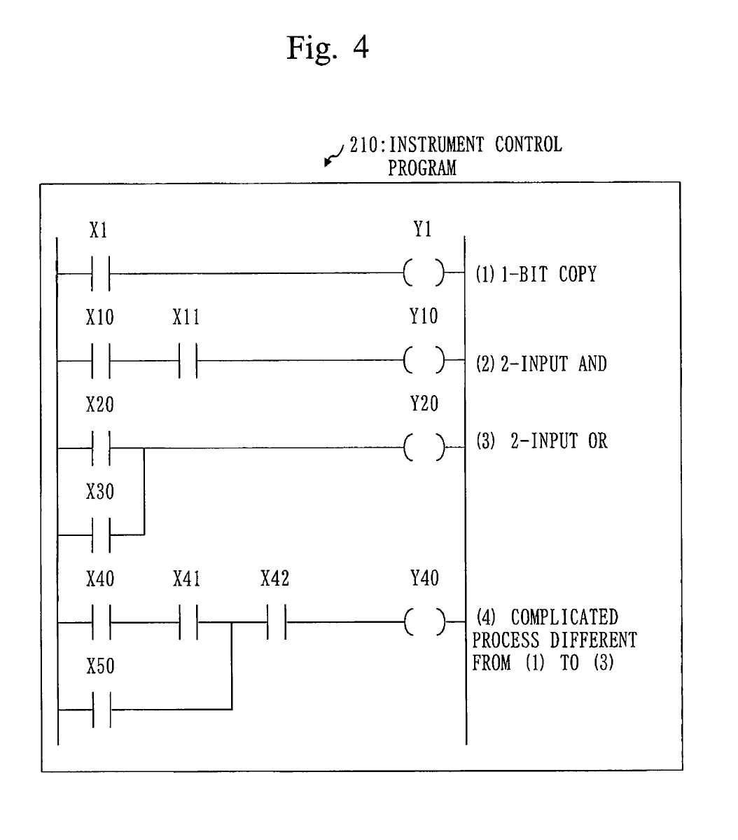

Practical examples of the target code extracting process (S111) and the extracted code list creating process (S112) will be described hereinafter with reference to FIGS. 4, 5, and 6.

FIG. 4 is a diagram illustrating an example of the instrument control program 210 according to Embodiment 1.

The instrument control program 210 illustrated in FIG. 4 is a ladder program described in the ladder language and includes command codes of (1) to (4).

The command code of (1) signifies 1-bit copy, the command code of (2) signifies calculating the logical product of two values, and the command code of (3) signifies outputting the logical sum of two values.

Xn represents a variable value that identifies an input device, and Yn represents a variable value that identifies an output device. This notion applies to drawings that follow FIG. 4 as well.

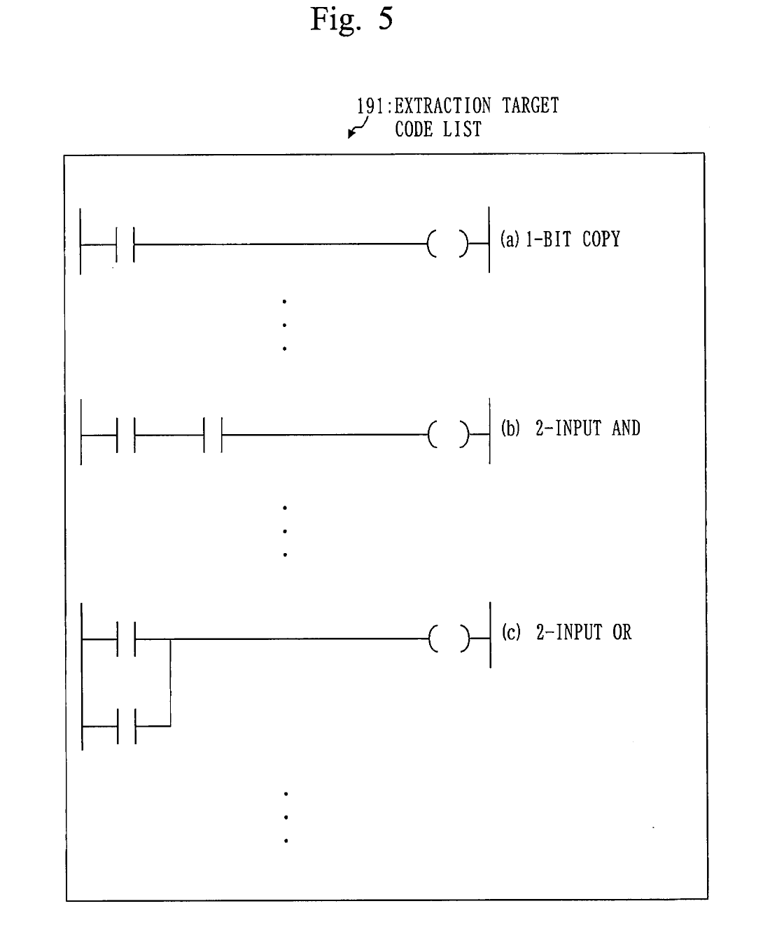

FIG. 5 is a diagram illustrating an example of the extraction target code list 191 according to Embodiment 1.

The extraction target code list 191 illustrated in FIG. 5 indicates extraction target codes of (a) to (c) described in the ladder language.

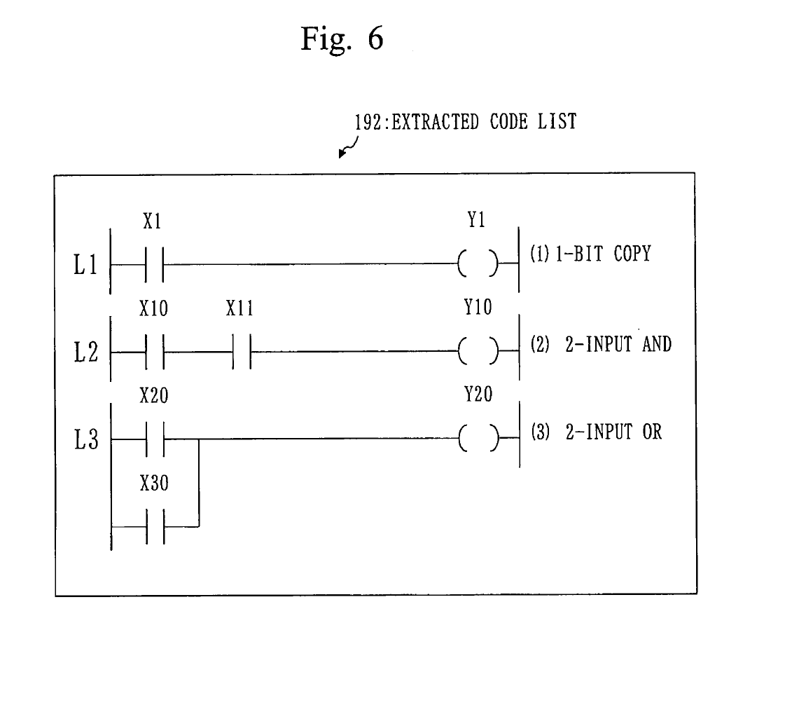

FIG. 6 is a diagram illustrating an example of the extracted code list 192 according to Embodiment 1.

The extracted code list 192 illustrated in FIG. 6 indicates extracted codes of (1) to (3) described in the ladder language.

The extracted code list 192 also indicates extracting portion identifies (for example, line number in the instrument control program 210) each identifying, for each extracted code, an extracting portion where the extracted code has been extracted. L1 to L3 in FIG. 6 denote the extracting portion identifiers. Ln signifies that a code has been extracted from the nth line in the instrument control program 210.

Of the command codes of (1) to (4) included in the instrument control program 210 of FIG. 4, the command codes of (1) to (3) are command codes that are the same as the extraction target codes of (a) to (c) indicated in the extraction target code list 191 of FIG. 5. The command codes of (1) to (3) are of the same code format type and the same command (arithmetic operation) type as those of the command codes of (a) to (c).

The command code of (4) of the instrument control program 210 is a command code that is different from any extraction target code indicated in the extraction target code list 191.

Accordingly, the command code extraction part 111 extracts the command codes of (1) to (3) from among the command codes of (1) to (4) included in the instrument control program 210 (S111 of FIG. 3), and creates the extracted code list 192 of FIG. 6 (S112 of FIG. 3).

Returning to FIG. 3, the explanation will resume with S113.

In S113, the sub-control program creation part 112 creates the sub-control program 212 including the extracted codes indicated in the extracted code list 192.

After S113, the process proceeds to S121.

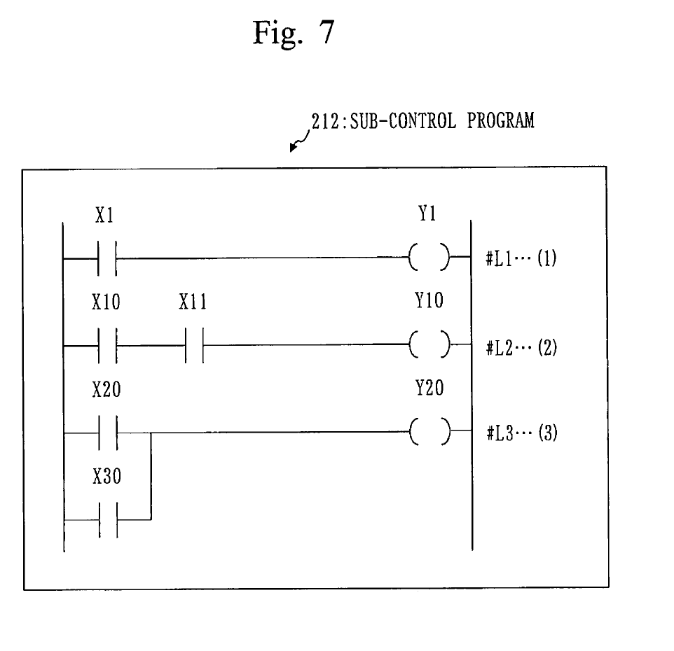

A practical example of the sub-control program creating process (S113) will be described with reference to FIG. 7.

FIG. 7 is a diagram illustrating an example of the sub-control program 212 according to Embodiment 1.

The sub-control program 212 indicated in FIG. 7 is a ladder program and includes command codes of (1) to (3).

The sub-control program creation part 112 creates the sub-control program 212 of FIG. 7 based on the extracted code list 192 of FIG. 6.

More specifically, the sub-control program creation part 112 creates the sub-control program 212 of FIG. 7 by arranging the extracted codes of (1) to (3) indicated in the extracted code list 192 of FIG. 6, according to the corresponding extracting portion identifiers Ln.

Also, the sub-control program creation part 112 may add extracting portion identifiers Ln to the extracted codes of (1) to (3). For example, the sub-control program creation part 112 adds a comment #Ln indicating an extracting portion identifier.

Returning to FIG. 3, the explanation will resume with S121.

In S121, the main control program creation part 121 creates the main control program 211 by removing the extracted codes indicated in the extracted code list 192 from the instrument control program 210.

After S121, the program editing process ends.

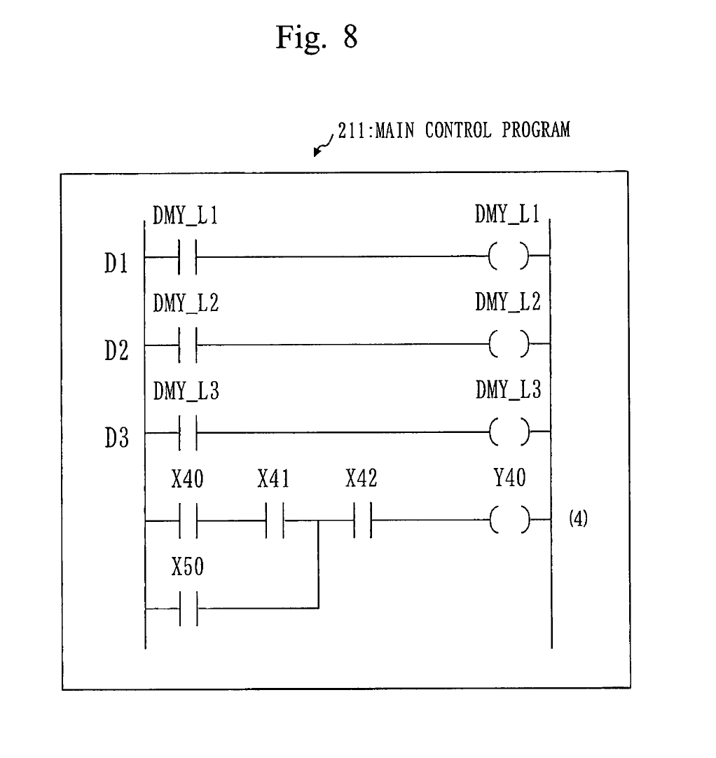

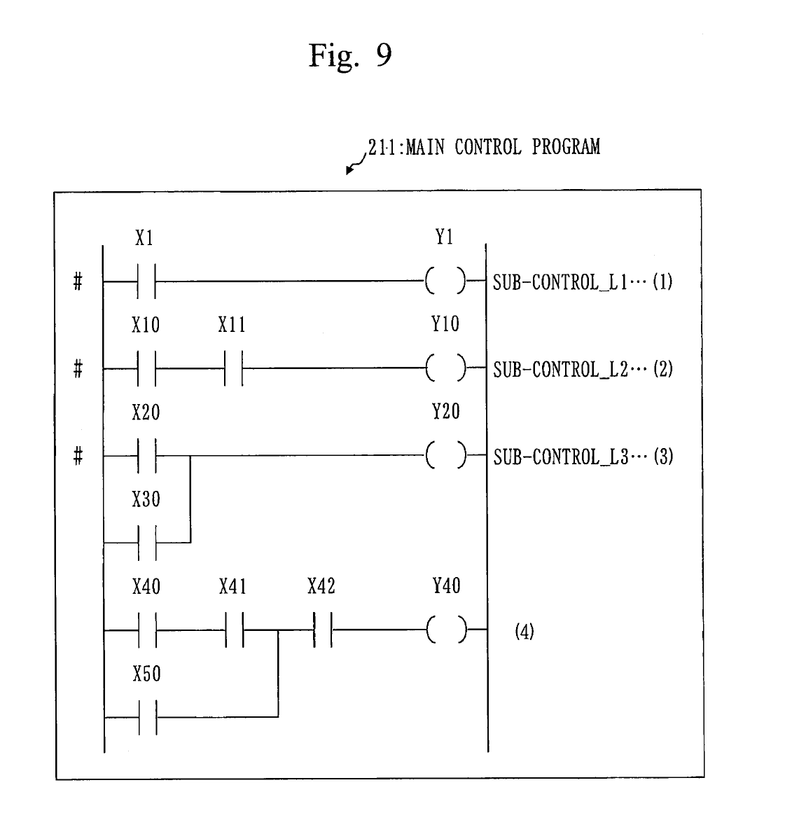

A practical example of the main control program creating process (S121) will be described hereinafter with reference to FIGS. 8 and 9.

FIG. 8 is a diagram illustrating an example of the main control program 211 according to Embodiment 1.

The main control program 211 indicated in FIG. 8 is a ladder program and includes dummy codes of D1 to D3 and a command code of (4). A dummy code is an invalid command code that will not be executed. Namely, even if the main control program 211 is compiled, an object code (also called execution code or machine code) corresponding to the dummy code will not be created.

Based on the instrument control program 210 of FIG. 4 and the extracted code list 192 of FIG. 6, the main control program creation part 121 creates the main control program 211 of FIG. 8.

More specifically, from among the command codes of (1) to (4) included in the instrument control program 210 of FIG. 4, the main control program creation part 121 specifies the command codes of (1) to (3) indicated in the extracted code list 192 of FIG. 6 according to their corresponding extracting portion identifiers Ln.

Then, the main control program creation part 121 replaces the specified command codes of (1) to (3) by dummy codes, thereby creating the main control program 211 of FIG. 8.

D1 to D3 of FIG. 8 are dummy codes. A character string DMY_Ln including an extracting portion identifier Ln of the corresponding extracted code is set in each dummy code.

FIG. 9 is a diagram illustrating an example of the main control program 211 according to Embodiment 1.

The main control program 211 indicated in FIG. 9 includes comment lines each attached with a symbol # and a command code of (4).

The main control program creation part 121 may create the main control program 211 of FIG. 9 based on the instrument control program 210 of FIG. 4 and the extracted code list 192 of FIG. 6.

More specifically, among the command codes of (1) to (4) included in the instrument control program 210 of FIG. 4, the main control program creation part 121 may replace the command codes of (1) to (3) indicated in the extracted code list 192 of FIG. 6 by comment lines, instead of replacing them by dummy codes.

The main control program creation part 121 may add a comment sub-control_Ln indicating that a corresponding command code is a command code migrated to the sub-control program 212, to a comment line.

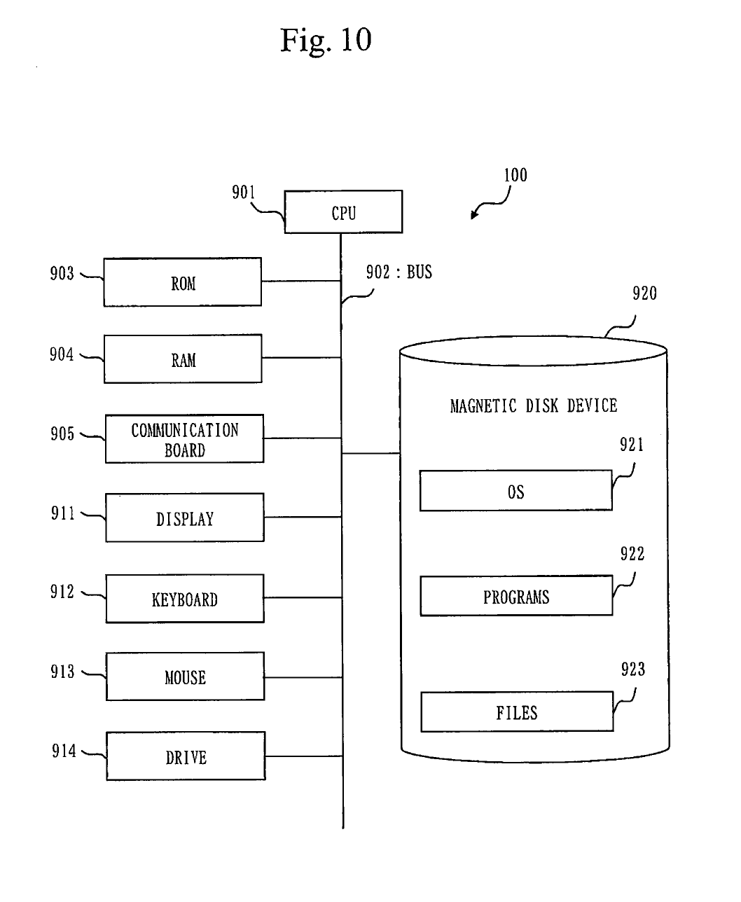

FIG. 10 is a diagram illustrating an example of the hardware resources of the program editing device 100 according to Embodiment 1.

Referring to FIG. 10, the program editing device 100 (an example of a computer) includes a CPU 901 (Central Processing Unit). The CPU 901 is connected to hardware devices such as a ROM 903, a RAM 904, a communication board 905 (communication device), a display 911 (display device), a keyboard 912, a mouse 913, a drive 914, and a magnetic disk device 920 via a bus 902, and controls these hardware devices. The drive 914 is a device that reads from and writes to a storage medium such as an FD (Flexible Disk), a CD (Compact Disc), or a DVD (Digital Versatile Disc).

The ROM 903, RAM 904, magnetic disk device 920, and drive 914 are examples of a storage device. The keyboard 912, mouse 913, and communication board 905 are examples of an input device. The display 911 and communication board 905 are examples of an output device.

The communication board 905 is connected to a communication network such as a LAN (Local Area Network), internet, or telephone line by wire or in a wireless manner.

The magnetic disk device 920 stores an OS 921 (Operating System), programs 922, and files 923.

The programs 922 include a program that executes a function explained as a “part” in the embodiment. The program (for example, a program editing program) is read and executed by the CPU 901. More specifically, the program causes the computer to function as the “part”, and causes the computer to execute the procedure and method of the “part”.

The files 923 include various types of data (input, output, decision result, calculation result, processing result, and the like) used in the “part” explained in the embodiment.

The arrows included in the configuration diagrams and flowcharts in the embodiment mainly indicate inputs and outputs of data and signals.

The process of the embodiment described based on the flowcharts and the like is executed using hardware such as the CPU 901, the storage device, the input device, and the output device.

What is explained as “part” in the embodiment may be “circuit”, “device”, or “instrument”; or “step”, “procedure”, or “process”. Namely, the “part” may be implemented as firmware, software, or hardware; or by a combination of them.

Embodiment 1 provides, for example, the following effects.

The program editing device 100 can automatically extract an input/output response control program (sub-control program) to be executed by a high-speed response input/output unit having an arithmetic operating function, from a control program to be executed on the CPU unit.

Embodiment 1 has described, for example, a program editing device (100). In the followings, the reference numerals and names of the corresponding constituent components are presented in parentheses.

The program editing device includes an extraction target code storage part (191), a command code extraction part (111), a second program creating part (112), and a first program creating part (121).

The extraction target code storage part stores, among a plurality of command codes included in a target program (210) to be executed by a first execution part (201) and a second execution part (202), a command code to be executed by the second execution part, as the extraction target codes.

The command code extraction part extract, from among the plurality of command codes included in the target program, a command code that is the same as the extraction target code stored in the extraction target code storage part, as an extracted code.

The second program creating part creates a program including the extracted code extracted by the command code extraction part, as a second program (212) to be executed by the second execution part.

The first program creating part creates, as a first program (211) to be executed by the first execution part, a program which is obtained by removing, from the target program, the extracted code extracted by the command code extracting part.

### Embodiment 2

An embodiment in which a sub-control program 212 is edited will be described.

Matters that are different from Embodiment 1 will mainly be described hereinafter. Matters that are not described are the same as Embodiment 1.

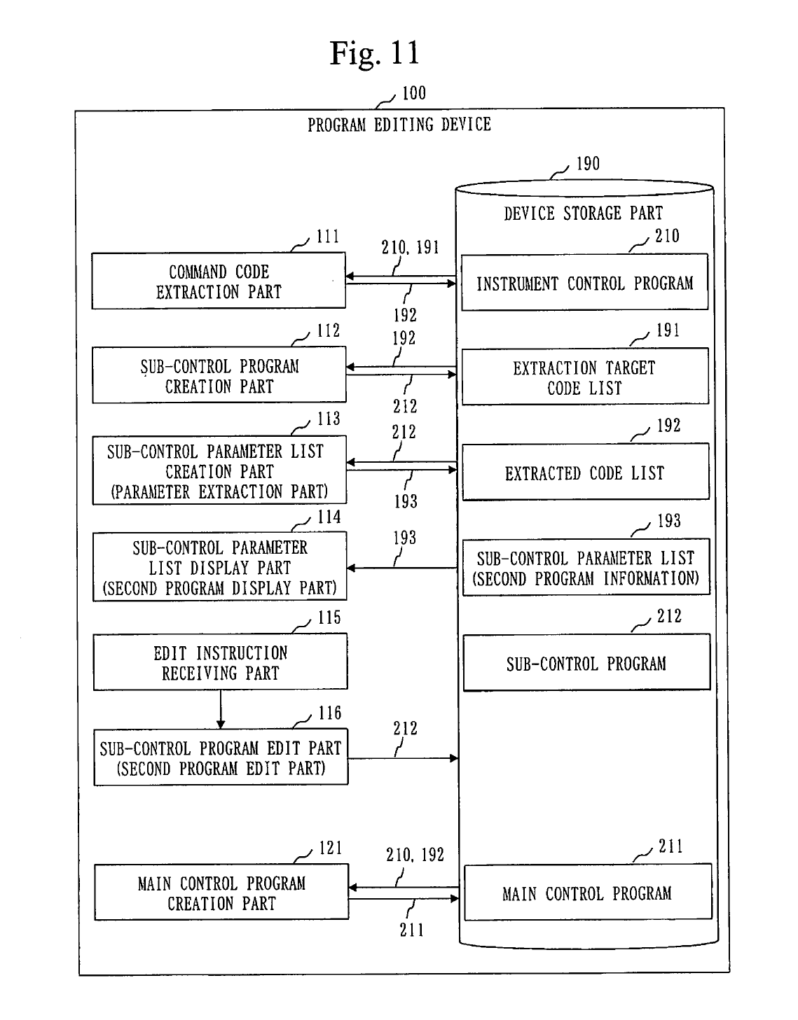

FIG. 11 is a functional configuration diagram of a program editing device 100 according to Embodiment 2.

The functional configuration of the program editing device 100 according to Embodiment 2 will be described with reference to FIG. 11.

The program editing device 100 includes a sub-control parameter list creation part 113 (an example of a parameter extraction part), a sub-control parameter list display part 114 (an example of a second program display part), an edit instruction receiving part 115, and a sub-control program edit part 116 (an example of a second program edit part), in addition to the configuration described in Embodiment 1 (see FIG. 2).

The sub-control parameter list creation part 113 creates a sub-control parameter list 193 (an example of second program information) based on the sub-control program 212 or an extracted code list 192.

The sub-control parameter list 193 indicates a listing of sub-control parameters constituting the command codes (to be called sub-control codes hereinafter) included in the sub-control program 212.

The sub-control parameters are constituent elements that make up command codes (sub-control codes) included in the sub-control program 212.

The sub-control parameter list display part 114 displays the sub-control parameters indicated in the sub-control parameter list 193.

The edit instruction receiving part 115 receives edit instructions for the sub-control parameters indicated in the sub-control parameter list 193.

The sub-control program edit part 116 edits the sub-control program 212 according to the edit instructions.

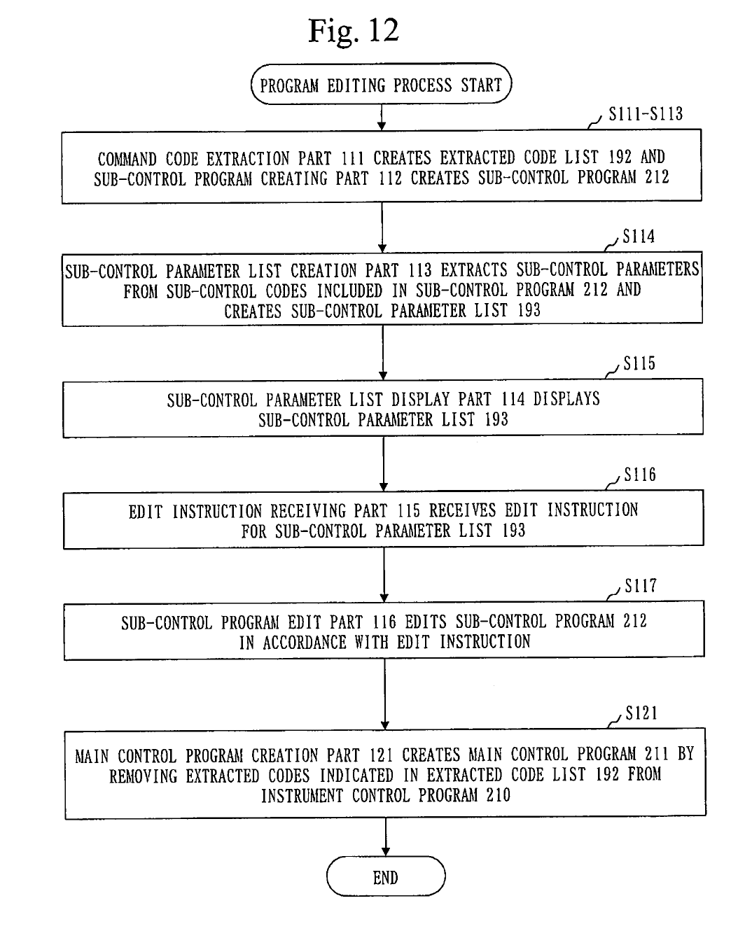

FIG. 12 is a flowchart illustrating a program editing process of the program editing device 100 according to Embodiment 2.

The program editing process of the program editing device 100 according to Embodiment 2 will be described with reference to FIG. 12.

The program editing process includes S114 to S117 in addition to the process described in Embodiment 1 (see FIG. 3).

In S111 to S113, a command code extraction part 111 creates the extracted code list 192, and a sub-control program creation part 112 creates the sub-control program 212 (the same as Embodiment 1).

After S113, the process proceeds to S114.

In S114, the sub-control parameter list creation part 113 extracts sub-control parameters from the sub-control codes (command codes) included in the sub-control program 212, and creates the sub-control parameter list 193 indicating a listing of the extracted sub-control parameters.

Alternatively, the sub-control parameter list creation part 113 may create the sub-control parameter list 193 using the extracted code list 192 instead of the sub-control program 212.

After S114, the process proceeds to S115.

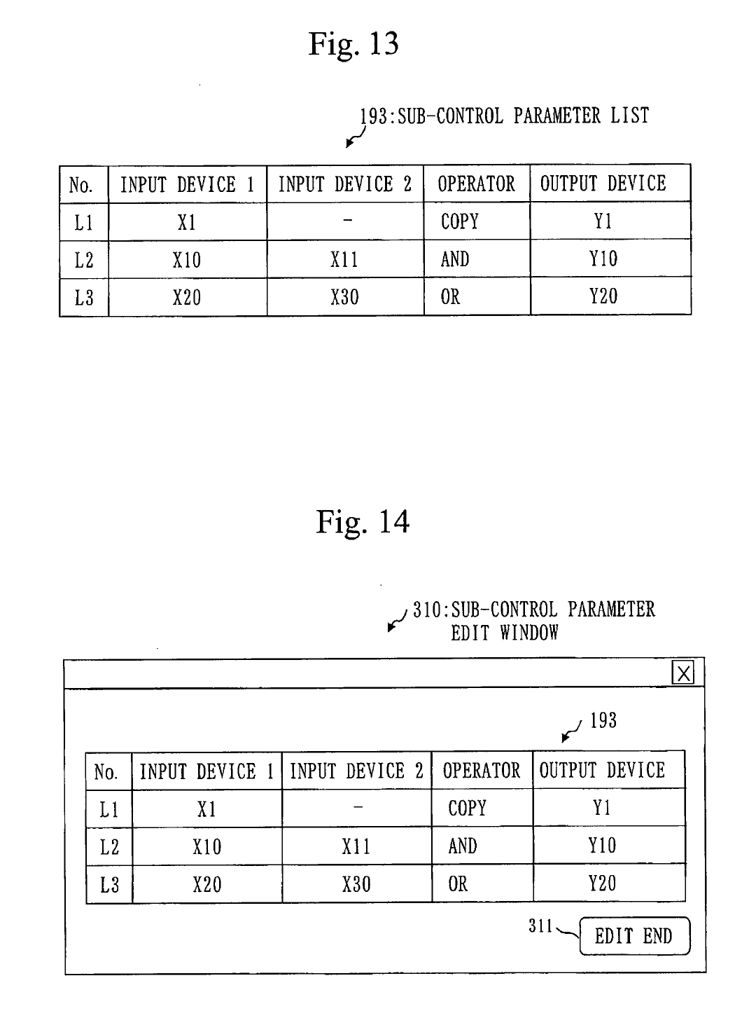

A practical example of a sub-control parameter list creating process (S114) will be described with reference to FIG. 13.

FIG. 13 is a diagram illustrating an example of the sub-control parameter list 193 according to Embodiment 2.

The sub-control parameter list 193 illustrated in FIG. 13 indicates sub-control parameters of No 1 to No 3.

The sub-control parameters include “No”, “Input Device 1”, “Input Device 2”, “Operator”, and “Output Device”.

“No.” represents an extracting portion identifier that identifies an extracting portion where the sub-control code has been extracted from the instrument control program 210.

“Input Device 1” represents an identifier that identifies a first input device, being a value input source, among constituent elements constituting the command code.

“Input Device 2” represents an identifier that identifies a second input device, being a value input source, among the constituent elements constituting the command code.

“Operator” represents an identifier that identifies the type of arithmetic operation among constituent elements constituting the command code.

“Output Device” is an identifier that identifies an output device, being a value output destination, among the constituent elements constituting the command code.

The sub-control parameter list creation part 113 creates the sub-control parameter list 193 of FIG. 13 based on the sub-control program 212 of FIG. 7.

More specifically, for each one of command codes of (1) to (3) included in the sub-control program 212 of FIG. 7, the sub-control parameter list creation part 113 extracts sub-control parameters from the command code.

Then, the sub-control parameter list creation part 113 creates the sub-control parameter list 193 of FIG. 13 which indicates, for each one of command codes (1) to (3), the sub-control parameters extracted from the command code.

Alternatively, the sub-control parameter list creation part 113 may create the sub-control parameter list 193 of FIG. 13 using the extracted code list 192 of FIG. 6 instead of the sub-control program 212 of FIG. 7.

In the sub-control parameter list 193 of FIG. 13, the sub-control parameters of L1 are sub-control parameters constituting the command code of (1), among command codes (1) to (3) of FIG. 7 or 6, which is associated with the extracting portion identifier L1.

Likewise, the sub-control parameters of L2 are sub-control parameters constituting the command code of (2) of FIG. 7 or 6. The sub-control parameters of L3 are sub-control parameters constituting the command code of (3) of FIG. 7 or 6.

Returning to FIG. 12, the explanation will resume with S115.

In S115, the sub-control parameter list display part 114 displays the sub-control parameters indicated in the sub-control parameter list 193.

For example, the sub-control parameter list display part 114 displays a sub-control parameter edit window 310 as illustrated in FIG. 14.

FIG. 14 is a diagram illustrating an example of the sub-control parameter edit window 310 according to Embodiment 1.

The sub-control parameter edit window 310 of FIG. 14 includes the sub-control parameter list 193 of FIG. 13 which is expressed in the table format.

Each display field of the sub-control parameter list 193 is an editable text box. An editing means (such as a pull-down list or menu) other than a text box may be employed instead.

The sub-control parameter edit window 310 also includes an edit end button 311 for instructing end of editing the sub-control parameter list 193.

After S115, the process proceeds to S116.

In S116, the user enters an edit instruction (add, change, delete, or the like) for the displayed sub-control parameter to the program editing device 100 using an input instrument such as a keyboard or mouse.

For example, the user changes an input device 1 of L1 displayed on the sub-control parameter edit window 310 of FIG. 14, from “X1” to “X2”, and depresses the edit end button 311.

Then, the edit instruction receiving part 115 receives the edit instruction entered by the user from the input instrument.

After S116, the process proceeds to S117.

In S117, the sub-control program edit part 116 edits the sub-control codes included in the sub-control program 212 in accordance with the edit instruction of the user.

For example, if the input device 1 of L1 on the sub-control parameter edit window 310 of FIG. 14 is changed from “X1” to “X2”, the sub-control program edit part 116 selects the sub-control code of (1) which is associated with the extracting portion identifier L1, from the sub-control codes of (1) to (3) included in the sub-control program 212 of FIG. 7. Then, the sub-control program edit part 116 changes the identifier of the input device included in the selected sub-control code (1), from “X1” to “X2”.

The sub-control program edit part 116 may also edit the sub-control parameter list 193 according to the edit instruction of the user and create a post-edit sub-control program 212 based on the post-edit sub-control parameter list 193.

After S117, the process proceeds to S121.

In S121, a main control program creation part 121 creates a main control program 211 by removing the extracted codes indicated in the extracted code list 192 from the instrument control program 210 (the same as Embodiment 1).

According to Embodiment 2, the user can edit the sub-control program 212 easily without any programming.

The user can also readily perceive the processing load share between the CPU unit and the input/output unit.

Embodiment 2 has described, for example, a program editing device (100) as follows. The reference numerals and names of the corresponding constituent components are presented in parentheses.

The program editing device 100 includes a second display part (114) and a second program edit part (116).

The second program display part displays second program information (193) representing the second program created by the second program creating part.

The second program edit part edits the second program in accordance with an edit instruction for the second program information displayed by the second program display part.

The program editing device includes a parameter extraction part (113) which extracts, for each command code of not less than one command code included in the second program, not less than one element constituting the command code, as a parameter.

The second program display part displays information indicating in a table format the parameter extracted by the parameter extraction part, as the second program information.

### Embodiment 3

An embodiment in which sub-control codes included in a sub-control program 212 are migrated to a main control program 211 will be described.

Matters that are different from Embodiment 2 will mainly be described hereinafter. Matters that are not described are the same as Embodiment 2.

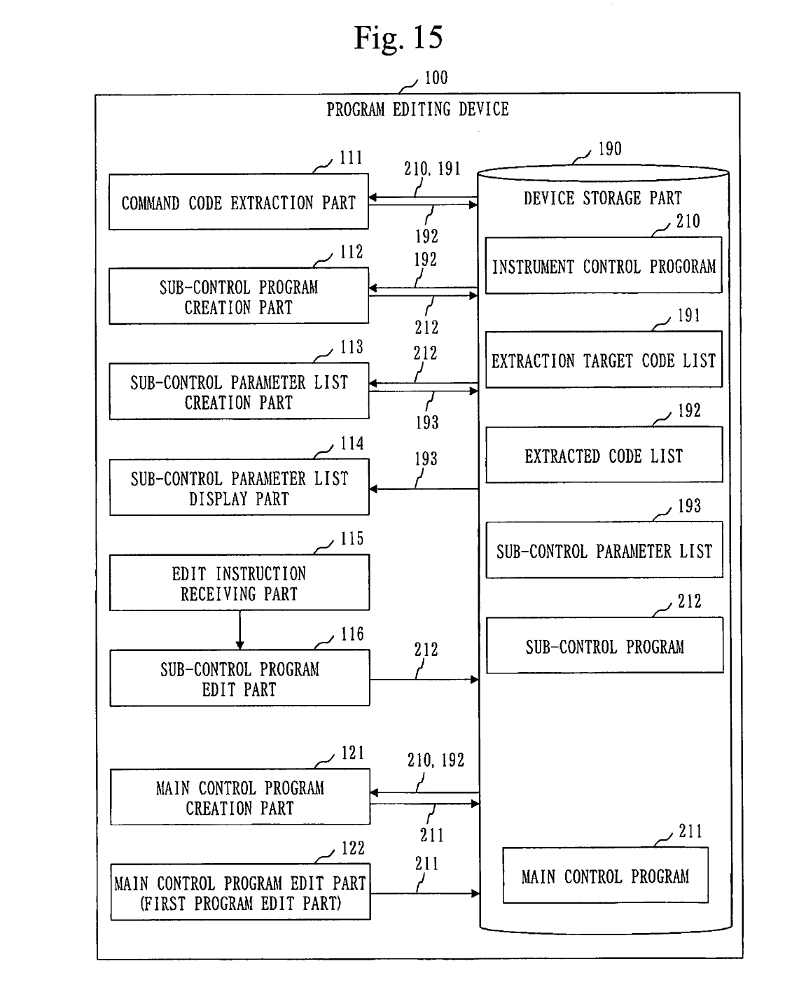

FIG. 15 is a functional configuration diagram of a program editing device 100 according to Embodiment 3.

The functional configuration of the program editing device 100 according to Embodiment 3 will be described with reference to FIG. 15.

The program editing device 100 includes a main control program edit part 122 (an example of a first program edit part) in addition to the configuration described in Embodiment 2 (see FIG. 11).

The main control program edit part 122 edits the main control program 211.

For example, among sub-control codes included in the sub-control program 212, the main control program edit part 122 adds the sub-control codes that are specified by the user, to the main control program 211.

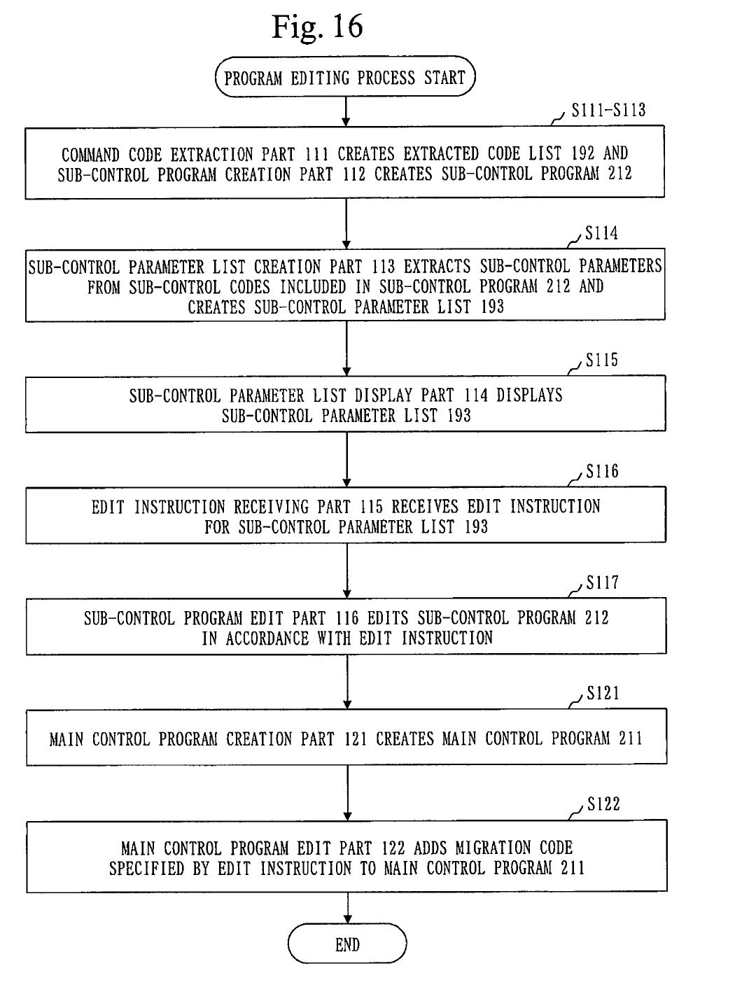

FIG. 16 is a flowchart illustrating the program editing process of the program editing device 100 according to Embodiment 3.

The program editing process of the program editing device 100 according to Embodiment 3 will be described with reference to FIG. 16.

The program editing process includes S122 in addition to the process described in Embodiment 2 (see FIG. 12).

In S111 through S113, a command code extraction part 111 creates an extracted code list 192, and a sub-control program creation part 112 creates the sub-control program 212 (the same as Embodiment 1).

After S113, the process proceeds to S114.

In S114, a sub-control parameter list creation part 113 creates the sub-control parameter list 193 (the same as Embodiment 2).

After S114, the process proceeds to S115.

In S115, a sub-control parameter list display part 114 displays the sub-control parameter list 193.

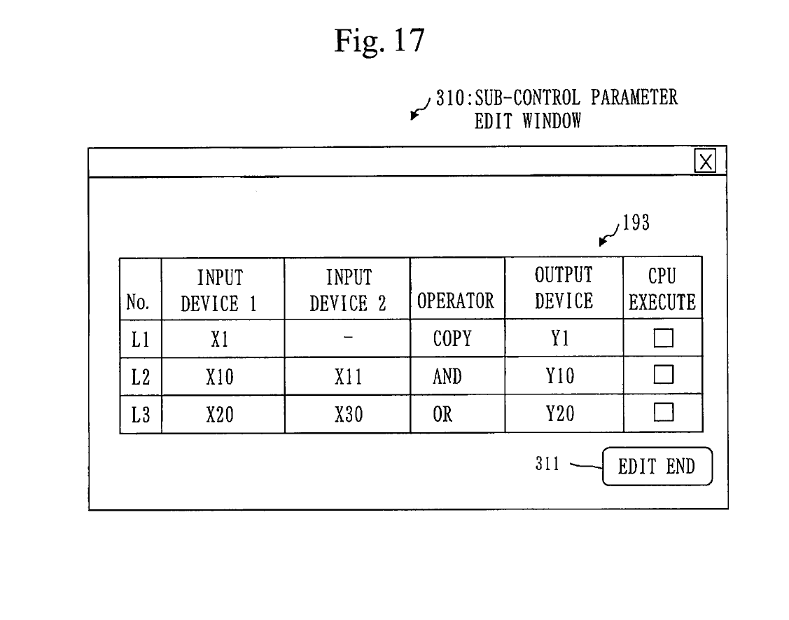

For example, the sub-control parameter list display part 114 displays a sub-control parameter edit window 310 as illustrated in FIG. 17.

FIG. 17 is a diagram illustrating an example of the sub-control parameter edit window 310 according to Embodiment 3.

The sub-control parameter edit window 310 of FIG. 17 is formed by adding “CPU execute” fields to the window described in Embodiment 2 (see FIG. 14).

Each “CPU execute” field includes a check box for specifying a sub-control code to be executed by a CPU unit 201, namely, a sub-control code to be migrated to a main control program 211.

Hereinafter, a sub-control code specified as a command code to be executed by the CPU unit 201, namely as a command code to be migrated to the main control program 211, will be referred to as a “migration code”.

After S115, the process proceeds to S116.

In S116, the user enters an edit instruction for the sub-control parameter to the program editing device 100, and an edit instruction receiving part 115 receives the edit instruction entered by the user (the same as Embodiment 2).

For example, if the user wishes to have the CPU unit 201 execute a sub-control code concerning the sub-control parameter of L1 displayed on the sub-control parameter edit window 310 of FIG. 17, the user checks the check box in the “CPU execute” field of L1.

After S116, the process proceeds to S117.

In S117, a sub-control program edit part 116 edits the sub-control parameter of the sub-control code included in the sub-control program 212, in accordance with the edit instruction of the user (the same as Embodiment 2).

For example, when the check box of the “CPU execute” field for L1 is checked in the sub-control parameter edit window 310 of FIG. 17, the sub-control program edit part 116 deletes the sub-control code of (1) associated with the extracting portion identifier L1, among the sub-control codes of (1) to (3) included in the sub-control program 212 of FIG. 7. The sub-control code of (1) is a migration code to be migrated to the main control program 211.

After S117, the process proceeds to S121.

In S121, a main control program creation part 121 creates the main control program 211 (the same as Embodiment 1).

After S121, the process proceeds to S122.

In S122, the main control program edit part 122 adds the migration code specified by the edit instruction of the user, to the main control program 211.

For example, when the check box of the “CPU execute” field for L1 is checked in the sub-control parameter edit window 310 of FIG. 17, the main control program edit part 122 selects a dummy code of D1 associated with an extracting portion identifier L1, from among dummy codes of D1 to D3 included in the main control program 211 of FIG. 8. The main control program edit part 122 then converts (restores) the selected dummy code of D1 into an ordinary command code, thereby adding a migration code to the main control program 211. The migration code to be added to the main control program 211 is a sub-control code of (1) which has been deleted from the sub-control program 212 in S117.

After S122, the program editing process ends. If, however, a migration code is not specified by the edit instruction of the user, the program editing process ends without performing S122.

According to Embodiment 3, the user can migrate sub-control codes included in the sub-control program 212 to the main control program 211.

Embodiment 3 has described, for example, a program editing device (100) as follows. The reference numerals and names of the corresponding constituent components are presented in parentheses.

The program editing device includes a first program edit part (122).

If the edit instruction for the second program information is a migration instruction that specifies any one command code included in the second program, as a migration code to be migrated to the first program, the first program edit part adds the migration code to the first program.

If the edit instruction is the migration instruction, the second program edit part (116) deletes the migration code from the second program.

### Embodiment 4

An embodiment will be described in which, where a command code of an instrument control program 210 is divisible into a plurality of command codes, a command code which is the same as an extraction target code is extracted from among divided command codes, and a sub-control program 212 is created.

Matters that are different from Embodiment 1 will be mainly described. Matters that are not described explained are the same as Embodiment 1.

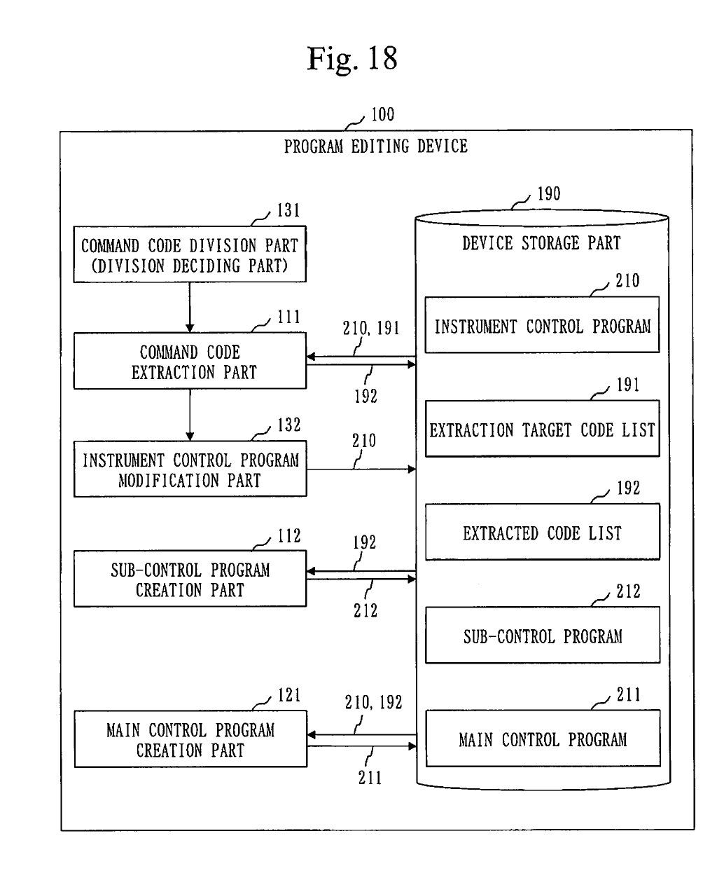

FIG. 18 is a functional configuration diagram of a program editing device 100 according to Embodiment 4.

The functional configuration of the program editing device 100 according to Embodiment 4 will be explained with reference to FIG. 18.

The program editing device 100 includes a command code division part 131 (an example of a division deciding part) and an instrument control program modification part 132, in addition to the configuration described in Embodiment 1 (see FIG. 2).

The command code division part 131 divides a command code, among the command codes included in the instrument control program 210, that can be divided into a plurality of command codes.

A command code that can be divided will be referred to as a “divisible code”, and a divided command code will be referred to as a “division code” hereinafter.

The instrument control program modification part 132 modifies (converts) a divisible code included in the instrument control program 210, into a plurality of division codes.

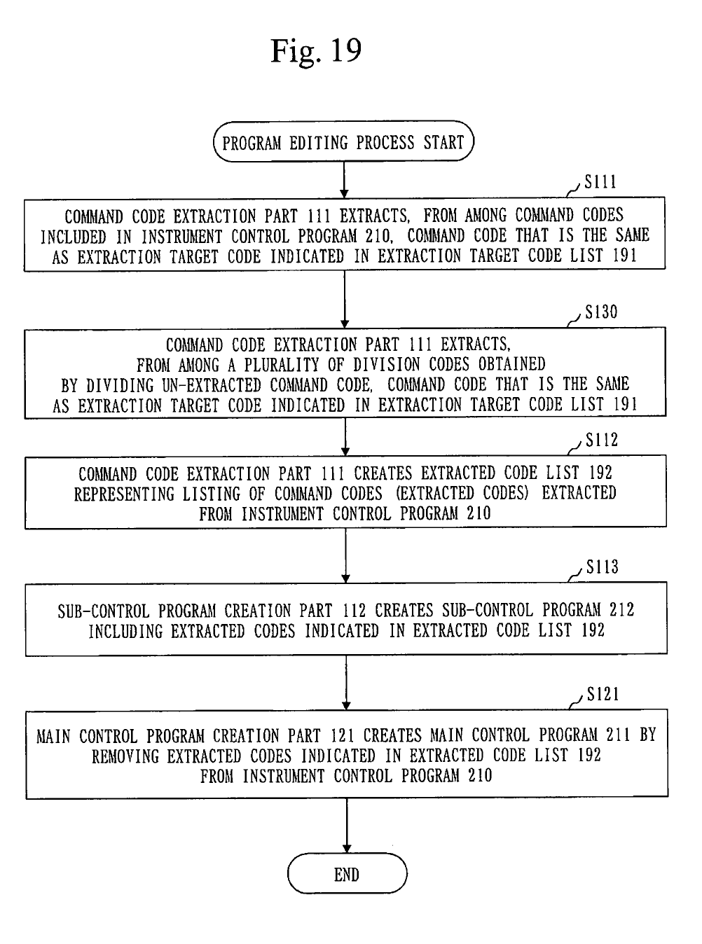

FIG. 19 is a flowchart illustrating a program editing process of the program editing device 100 according to Embodiment 4.

The program editing process of the program editing device 100 according to Embodiment 4 will be described with reference to FIG. 19.

The program editing process includes S130 in addition to the process described in Embodiment 1 (see FIG. 3).

In S130, a command code extraction part 111 extracts a command code that is the same as an extraction target code indicated in an extraction target code list 191, from among the plurality of division codes obtained by dividing an un-extracted command code which has not been extracted in S111.

The command code extracted in S130 is set in an extracted code list 192 together with the command code extracted in S111 (S112).

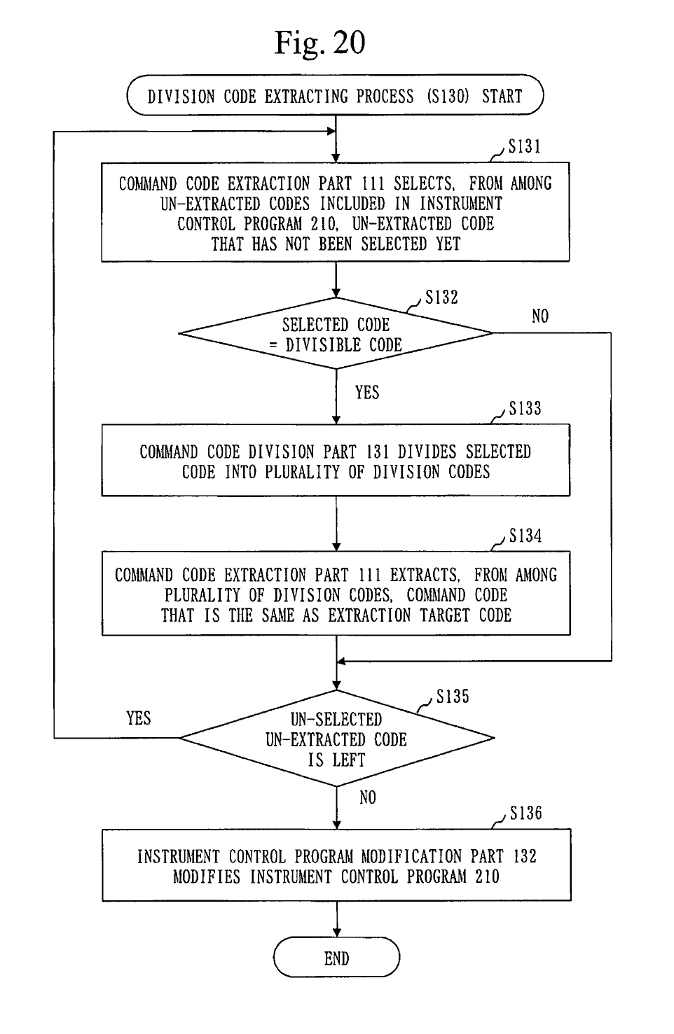

FIG. 20 is a flowchart illustrating an example of a division code extracting process (S130) according to Embodiment 4.

An example of the division code extracting process (S130) according to Embodiment 4 will be described with reference to FIG. 20.

In S131, the command code extraction part 111 selects one un-extracted code that has not been selected yet, from among the un-extracted command codes included in the instrument control program 210.

For example, the command code extraction part 111 selects un-extracted codes included in the instrument control program 210, one at a time sequentially starting with the head.

The un-extracted code is, among the command codes included in the instrument control program 210, a command code that has not been extracted in S111 (see FIG. 19).

An un-extracted code selected in S131 will be referred to as a “selected code” hereinafter.

After S131, the process proceeds to S132.

In S132, the command code division part 131 decides whether or not the selected code is a divisible code that can be divided into a plurality of command codes.

For example, the divisible code is a command code in which, as an output destination an output value is to be outputted to, a plurality of output destinations are specified. A command code in which a first output destination and a second output destination are specified can be divided into two command codes, namely, a first command code which outputs an output value to the first output destination and a second command code which outputs an output value to the second output destination.

A division enabling condition under which a command code is a divisible code is determined in advance by a program, a table, or the like. Where a selected code satisfies the division enabling condition, the command code division part 131 decides that the selected code is a divisible code.

If the selected code is a divisible code (YES), the process proceeds to S133.

If the selected code is not a divisible code (NO), the process proceeds to S135.

In S133, the command code division part 131 duplicates the selected code included in the instrument control program 210, and divides the duplicated selected code into a plurality of division codes.

For example, the command code division part 131 divides a selected code in which a first output destination and a second output destination are specified, into two division codes, namely, a first division code which outputs an output value to the first output destination and a second division code which outputs an output value to the second output destination.

A division procedure for dividing the selected code into a plurality of division codes is determined in advance by a program, a table, or the like. The command code division part 131 divides the selected code into a plurality of division codes in accordance with the division procedure.

After S133, the process proceeds to S134.

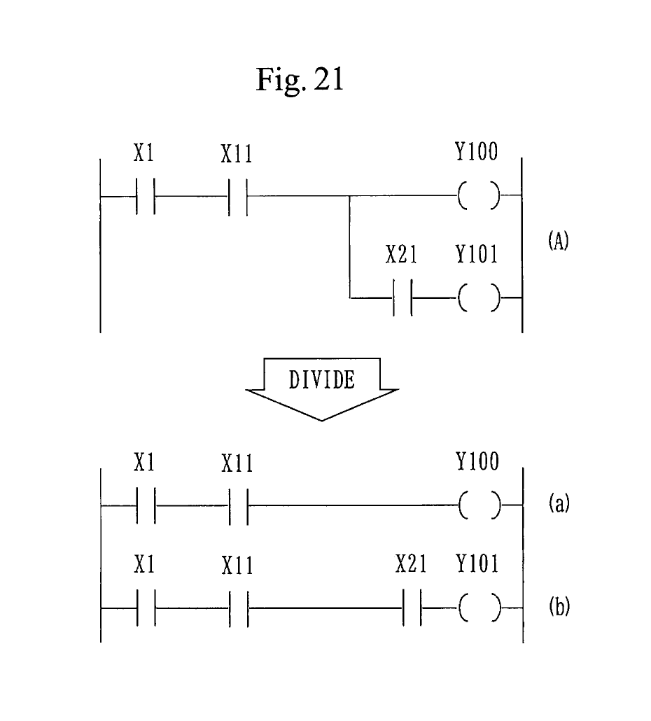

FIG. 21 is a diagram illustrating a practical example of a command code dividing process (S133) according to Embodiment 4.

In FIG. 21, (A) is a divisible code which outputs a first output value as the logical product of an input value from X1 and an input value from X11, to Y100, and a second output value as the logical product of the first output value and an input value from X21, to Y101.

The command code division part 131 divides the divisible code of (A) into two division codes that are a first division code (a) which outputs the first output value to Y100 and a second division code (b) which outputs the second output value to Y101.

Returning to FIG. 20, the explanation will resume with S134.

In S134, the command code extraction part 111 extracts, from among the plurality of division codes, a command code which is the same as an extraction target code indicated in the extraction target code list 191.

In the process of S134, a command code included in the instrument control program 210 in S111 of FIG. 19 is replaced by a plurality of division codes.

After S134, the process proceeds to S135.

In S135, the command code extraction part 111 decides whether or not an un-selected un-extracted code that has not been selected in S131 is left.

If an un-selected un-extracted code is left (YES), the process returns to S131.

If an un-selected un-extracted code is not left (NO), the process proceeds to S136.

In S136, among un-extracted codes included in the instrument control program 210, the instrument control program modification part 132 modifies (converts) an un-extracted code that is the same as a divisible code being the division source of the division code extracted in S134, into a plurality of division codes.

After S136, the division code extracting process (S130) ends.

Embodiment 4 may be an embodiment in which the sub-control program 212 can be edited, as in Embodiment 2, or an embodiment in which the sub-control code included in the sub-control program 212 can be migrated to the main control program 211, as in Embodiment 3.

According to Embodiment 4, when the command code of the instrument control program 210 is divisible into a plurality of command codes, the program editing device 100 can extract a command code that is the same as the extraction target code, from among divided command codes, and create the sub-control program 212.

Embodiment 4 has described, for example, a program editing device (100) as follows. The reference numerals and names of the corresponding constituent components are presented in parentheses.

The program editing device includes a division deciding part (131) and a command code division part (131).

The division deciding part decides whether or not, among the plurality of command codes included in the target program (210), an un-extracted code being a command code not extracted by the command code extraction part is a command code that is divisible into a plurality of command codes.

If the division deciding part decides that the un-extracted code is a divisible command code, the command code division part divides the un-extracted code into a plurality of command codes.

The command code extraction part (111) extracts, from among the plurality of command codes obtained by the command code division part, a command code that is the same as the extraction target code, as a new extracted code.

### Embodiment 5

An embodiment in which a condition for extracting a command code is set will be described.

Matters that are different from Embodiment 1 will mainly be described hereinafter. Matters that are not described are the same as Embodiment 1.

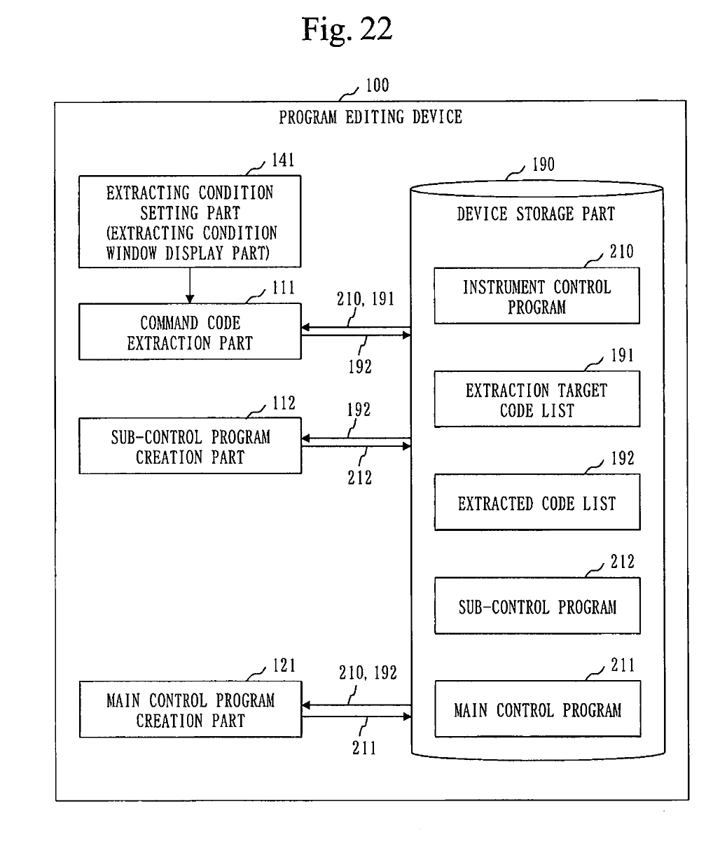

FIG. 22 is a functional configuration diagram of a program editing device 100 according to Embodiment 5.

The functional configuration of the program editing device 100 according to Embodiment 5 will be described with reference to FIG. 22.

The program editing device 100 includes an extracting condition setting part 141 (an example of an extracting condition window display part) in addition to the configuration described in Embodiment 1 (see FIG. 2).

The extracting condition setting part 141 sets an extracting condition for extracting a command code from an instrument control program 210.

A command code extraction part 111 extracts, in addition to the command code which is the same as the extraction target code indicated in an extraction target code list 191, a command code that satisfies the extracting condition set by the extracting condition setting part 141 from the instrument control program 210, and generates an extracted code list 192.

Note that the command code extraction part 111 may generate the extracted code list 192 by specifying, among the extraction target codes indicated in the extraction target code list 191, an extraction target code that satisfies the extracting condition, and extracting a command code that is the same as the specified extraction target code.

An extracting condition setting process of the extracting condition setting part 141 will be explained hereinafter.

(1) The extracting condition setting part 141 displays an extracting condition window 320 for setting an extracting condition.

(2) Using an input instrument, the user enters an extracting condition to the extracting condition window 320.

(3) The extracting condition setting part 141 receives the extracting condition entered to the extracting condition window 320 from the input instrument.

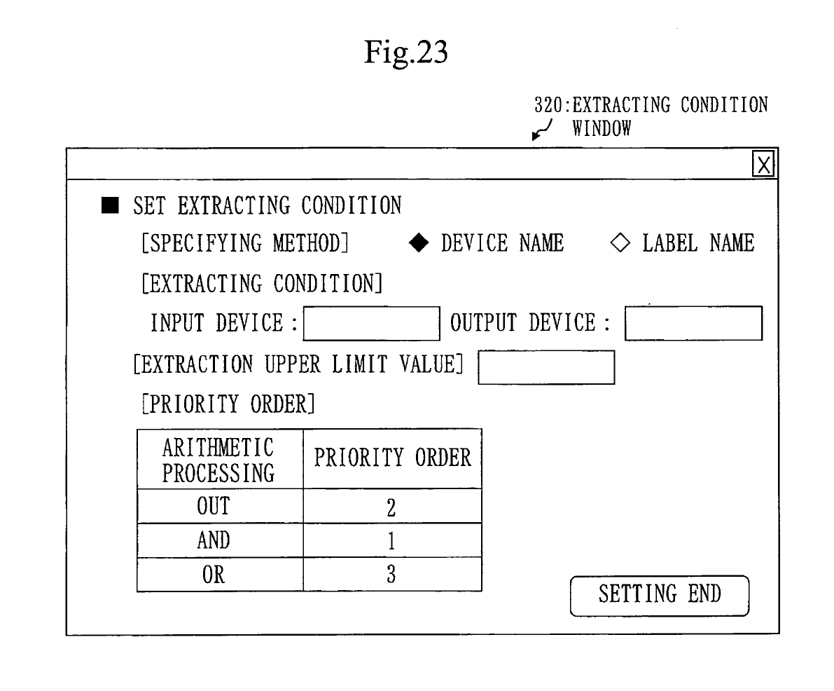

FIG. 23 is a diagram illustrating an example of the extracting condition window 320 according to Embodiment 5.

An example of the extracting condition window 320 according to Embodiment 5 will be described with reference to FIG. 23.

The extracting condition window 320 includes “specifying method”, “extracting condition”, “extraction upper limit value”, and “priority order” as items to be specified for setting the extracting condition.

The extracting condition window 320 also includes a setting end button for ending extracting condition setting.

The “specifying method” is an item for selecting a method of specifying input/output devices. An input device is the input source of an input value and an output device is the output destination of an output value. For example, the “specifying method” is configured using a check box.

The specifying method includes a method of specifying the input/output device by “device name” and a method of specifying the input/output device by “label name”.

With the “device name”, the input/output device is identified by characters such as alphabets or numerals. With the “label name”, the input/output device is identified by a natural language.

The “extracting condition” is an item for specifying the input/output device.

The “extraction upper limit value” is an item for specifying the upper limit value of the number of command codes to be extracted.

The “priority order” is an item for specifying an operator included in the command code. With the “priority order”, the priority order of the operator is specified.

For example, the “extracting condition”, “extracting upper limit value”, and “priority order” are each configured by a check box.

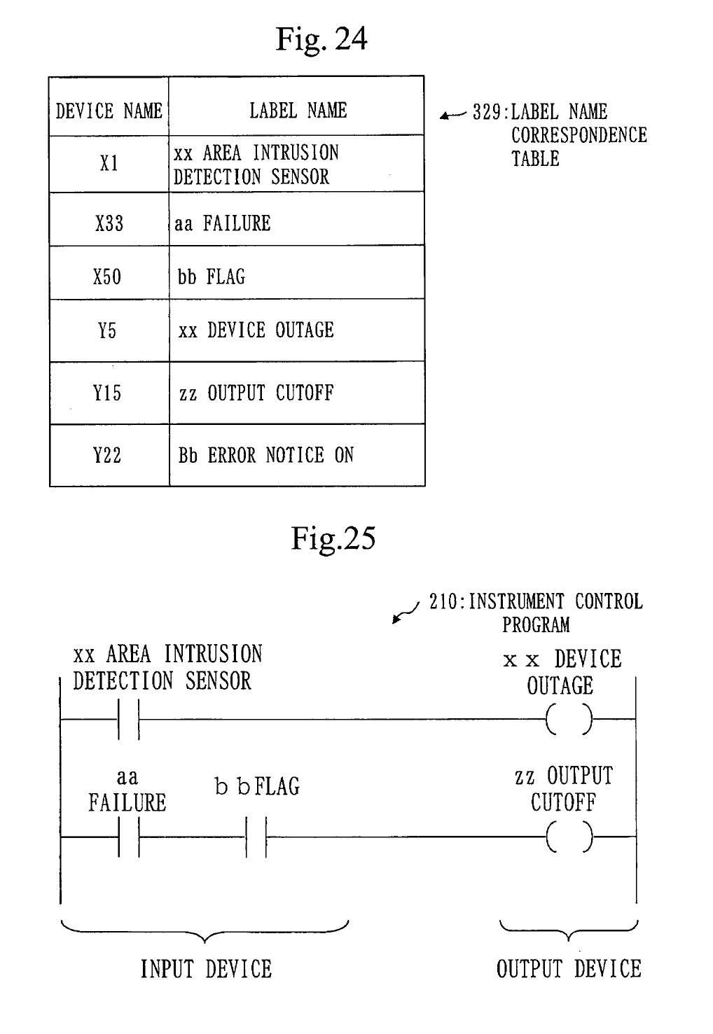

FIG. 24 is a diagram illustrating an example of a label name correspondence table 329 according to Embodiment 5.

The label name correspondence table 329 is a table that shows the correspondence between a device name and a label name.

The program editing device 100 may preferably store the label name correspondence table 329 as illustrated in FIG. 24.

Using the label name correspondence table 329, the extracting condition setting part 141 can convert the device name specified on the extracting condition window 320 into the label name.

Also, using the label name correspondence table 329, the extracting condition setting part 141 can convert the label name specified on the extracting condition window 320 into the device name.

FIG. 25 is a diagram illustrating an example of the instrument control program 210 according to Embodiment 5.

As illustrated in FIG. 25, there is a case where the instrument control program 210 is created using the label names of the input/output devices.

In this case, using the label name correspondence table 329 (see FIG. 4), the command code extraction part 111 can convert the label name written in the instrument control program 210 into the device name.

If the instrument control program 210 is created using the device names of the input/output devices, the command code extraction part 111 can convert the device name written in the instrument control program 210 into the label name, using the label name correspondence table 329.

Embodiment 5 may be an embodiment in which a sub-control program 212 can be edited as in Embodiment 2, or an embodiment in which the sub-control codes included in the sub-control program 212 can be migrated to a main control program 211 as in Embodiment 3.

Embodiment 5 may also be an embodiment in which division codes obtained by dividing a command code are extracted as in Embodiment 4.

According to Embodiment 5, the user can set an extracting condition for the command code.

In Embodiment 5, for example, a program editing device (100) as follows has been described. The reference numerals and names of the corresponding constituent components are presented in parentheses.

The program editing device includes an extracting condition window display part (141) to display an extracting condition window (320) for specifying an extracting condition under which a command code is to be extracted from the target program (210).

The command code extraction part (111) extracts, from among the plurality of command codes included in the target program, a command code that satisfies the extracting condition specified on the extracting condition window, as a new extracted code.

### Embodiment 6

An embodiment will be described in which a command code existing in both a main control program 211 and a sub-control parameter list 193 in a duplicate manner is extracted.

Matters that are different from Embodiment 2 will mainly be described hereinafter. Matters that are not described are the same as Embodiment 2.

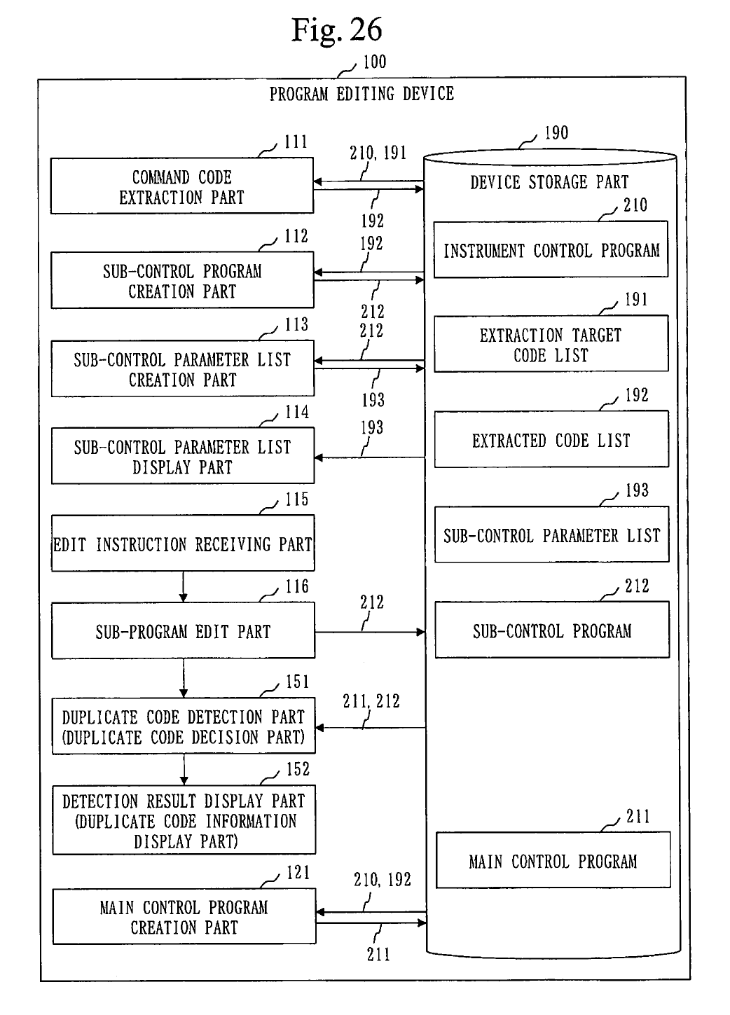

FIG. 26 is a functional configuration diagram of a program editing device 100 according to Embodiment 6.

The functional configuration of the program editing device 100 according to Embodiment 6 will be described with reference to FIG. 26.

The program editing device 100 includes a duplicate code detection part 151 (an example of a duplicate code decision part) and a detection result display part 152 (an example of a duplicate code information display part), in addition to the configuration described in Embodiment 2 (see FIG. 11).

The duplicate code detection part 151 detects a command code (to be referred to as a duplicate code hereinafter) existing in both the main control program 211 and the sub-control parameter list 193 in a duplicate manner.

The detection result display part 152 displays the detection result of the duplicate code.

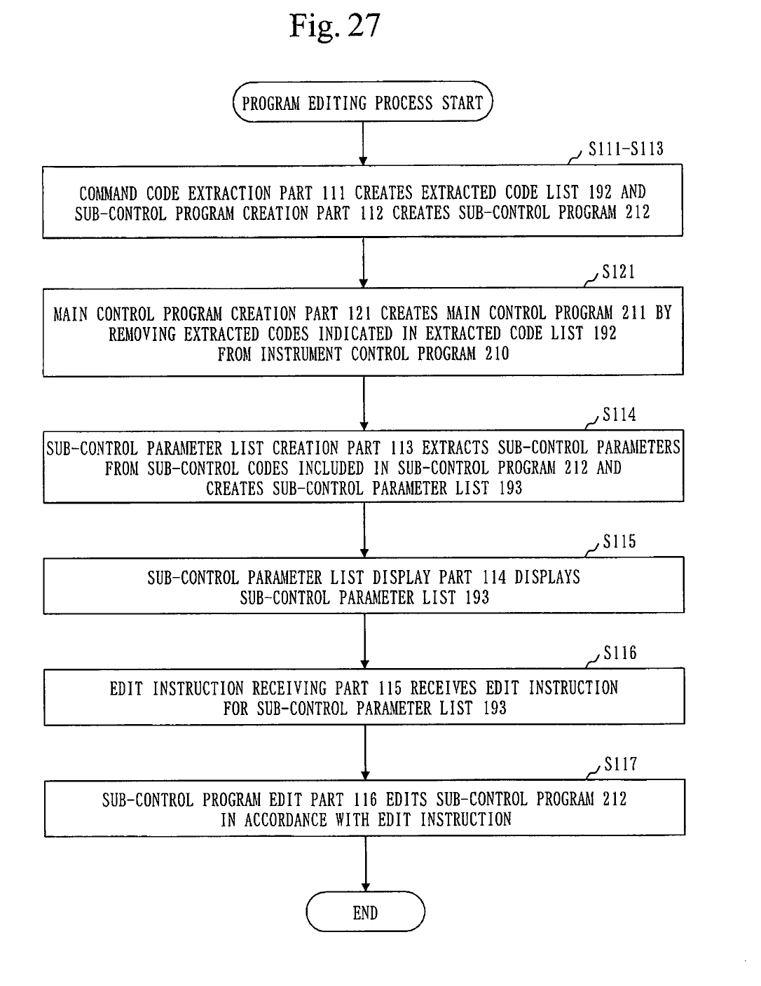

FIG. 27 is a flowchart illustrating the program editing process of the program editing device 100 according to Embodiment 6.

As illustrated in FIG. 27, the program editing device 100 executes a main program creating process (S121) prior to a sub-control program editing process (S117).

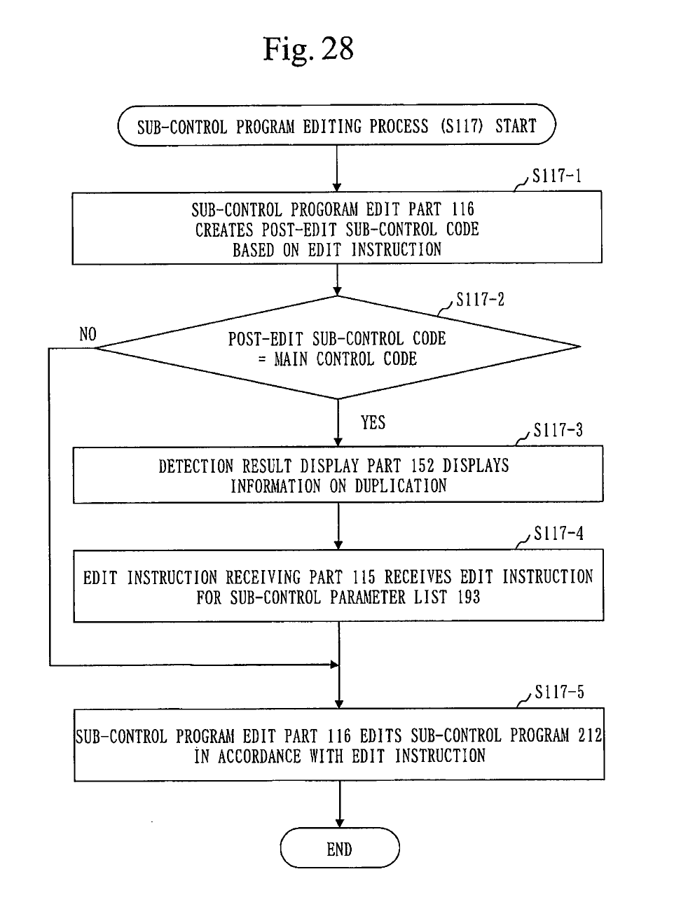

FIG. 28 is a flowchart illustrating the sub-control program editing process (S117) according to Embodiment 6.

The sub-control program editing process (S117) according to Embodiment 6 will be described with reference to FIG. 28.

In S117-1, a sub-control program edit part 116 creates a post-edit sub-control code based on the edit instruction entered in S116 and the sub-control parameter which has been edit-instructed in S116.

After S117-1, the process proceeds to S117-2.

In S117-2, the duplicate code detection part 151 decides whether or not the post-edit sub-control code and the main control code which is included in the main control program 211 are duplicative.

Duplicative command codes (duplicate codes) may be either those command codes in which all variable values are the same between the command codes, or those command codes in which at least some variable values are the same between the command codes.

For example, if the output device specified by a post-edit sub-control code and the output device specified by a main control code included in the main control program 211 are the same, the duplicate code detection part 151 decides that the post-edit sub-control code and the main control code are duplicative.

If the post-edit sub-control code and the main control code are duplicative (YES), the process proceeds to S117-3.

If the post-edit sub-control code and the main control code are not duplicative (NO), the process proceeds to S117-5. Prior to S117-5, the detection result display part 152 may display a notice or message indicating that the post-edit sub-control code and the main control code are not duplicative.

In S117-3, the detection result display part 152 displays a notice or message indicating that the post-edit sub-control code and the main control code are duplicative.

By displaying this, the detection result display part 152 prompts the user to modify the sub-control parameter.

After S117-3, the process proceeds to S117-4.

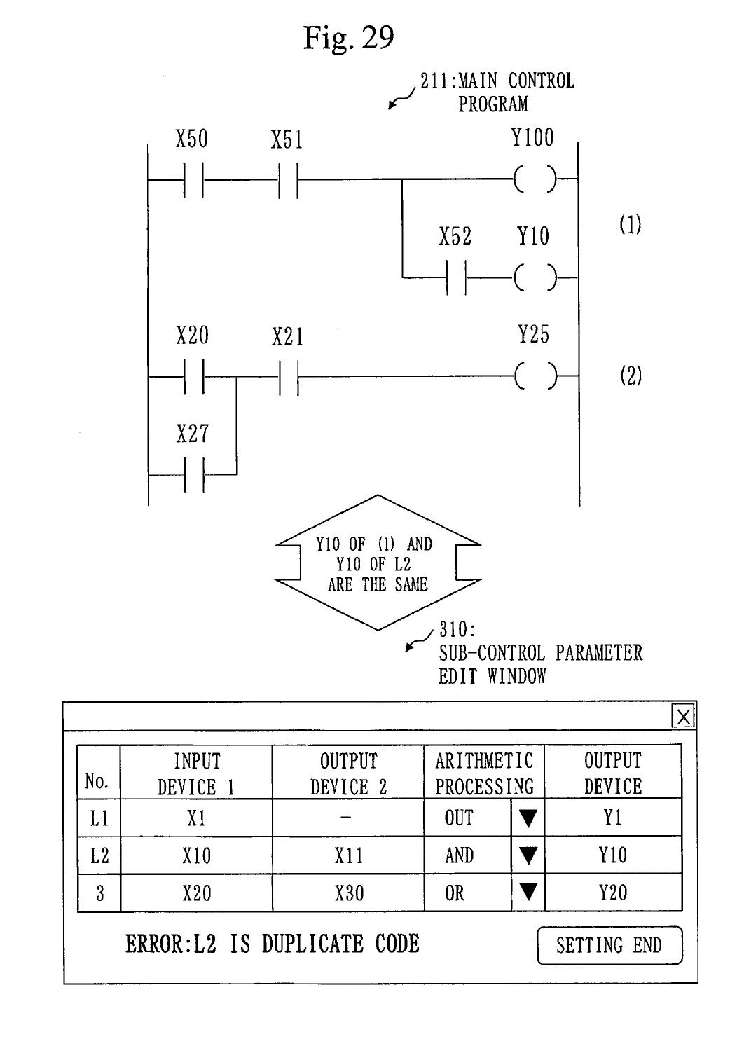

FIG. 29 is a diagram illustrating a practical example of a detection result display process (S117-3) according to Embodiment 6.

In FIG. 29, the output device for the main control code (1) of the main control program 211 and the output device for the sub-control code L2 are both “Y10”.

Accordingly, the duplicate code detection part 151 decides that the main control code (1) and the sub-control code L2 are duplicative.

The detection result display part 152 then displays a message on the sub-control parameter edit window 310 to indicate that the sub-control code L2 is a duplicate code.

In S117-4, using an input instrument, the user instructs an edit (for example, to delete the sub-control code) for the sub-control code which is duplicative with the main control code.

Then, an edit instruction receiving part 115 receives the edit instruction from the input instrument.

After S117-4, the process proceeds to S117-5.

In S117-5, the sub-control program edit part 116 edits a sub-control program 212 in accordance with the edit instruction entered in S116 and the edit instruction entered in S117-4.

According to Embodiment 6, the program editing device 100 can detect a command code which is duplicative between the main control program 211 and the sub-control parameter list 193.

Embodiment 6 has described, for example, a program editing device (100) as follows. The reference numerals and names of the corresponding constituent components are presented in parentheses.

The program editing device includes a duplicate code deciding part (151) and a duplicate code information display part (152).

The duplicate code deciding part decides whether or not a duplicate code being a command code duplicative with a command code included in the first program (211) is included in the second program (212), based on the edit instruction.

If the duplicate code deciding part decides that the duplicate code is included in the second program, the duplicate code information display part displays duplicate code information indicating that the duplicate code is included in the second program.

The embodiments may be combined entirely or partly within a range where no inconsistency occurs.

### REFERENCE SIGNS LIST

100: program editing device; 111: command code extraction part; 112: sub-control program creation part; 113: sub-control parameter list creation part; 114: sub-control parameter list display part; 115: edit instruction receiving part; 116: sub-control program edit part; 121: main control program creation part; 122: main control program edit part; 131: command code division part; 132: instrument control program modification part; 141: extracting condition setting part; 151: duplicate code detection part; 152: detection result display part; 190: device storage part; 191: extraction target code list; 192: extracted code list; 193: sub-control parameter list; 200: instrument control device; 201: CPU unit; 202: input/output unit; 204: network; 209: peripheral; 210: instrument control program; 211: main control program; 212: sub-control program; 310: sub-control parameter edit window; 311: edit end button; 320: extracting condition window; 329: label name correspondence table; 901: CPU; 902: bus; 903: ROM; 904: RAM; 905: communication board; 911: display; 912: keyboard; 913: mouse; 914: drive; 920: magnetic disk device; 921: OS; 922: programs; 923: files

1. A program editing device comprising:
an extraction target code storage part to store, among a plurality of command codes included in a target program to be executed by a first execution part and a second execution part, a command code to be executed by the second execution part, as an extraction target code;
a command code extraction part to extract, from among the plurality of command codes included in the target program, a command code that is the same as the extraction target code stored in the extraction target code storage part, as an extracted code;
a second program creating part to create, as a second program to be executed by the second execution part, a program including the extracted code extracted by the command code extraction part; and
a first program creating part to create, as a first program to be executed by the first execution part, a program which is obtained by removing from the target program, the extracted code extracted by the command code extracting part.

2. The program editing device according to claim 1, comprising:
a second program display part to display second program information representing the second program created by the second program creating part; and
a second program edit part to edit the second program in accordance with an edit instruction for the second program information displayed by the second program display part.

3. The program editing device according to claim 2, comprising:
a parameter extraction part to extract, from each of one or more command codes included in the second program, each of one or more elements constituting the command code, as a parameter,
wherein the second program display part displays information indicating in a table format each parameter extracted by the parameter extraction part, as the second program information.

4. The program editing device according to claim 2, comprising:
a first program edit part to add, if the edit instruction for the second program information is a migration instruction that specifies any one command code included in the second program, as a migration code to be migrated to the first program, the migration code to the first program,
wherein, if the edit instruction is the migration instruction, the second program edit part deletes the migration code from the second program.

5. The program editing device according to claim 2, comprising:
a duplicate code deciding part to decide whether or not a duplicate code being a command code duplicative with a command code included in the first program is included in the second program, based on the edit instruction; and
a duplicate code information display part to display, if the duplicate code deciding part decides that the duplicate code is included in the second program, duplicate code information indicating that the duplicate code is included in the second program.

6. The program editing device according to claim 1, comprising:
a division deciding part to decide whether or not, among the plurality of command codes included in the target program, an un-extracted code being a command code not extracted by the command code extraction part is a command code that is divisible into a plurality of command codes; and
a command code division part to divide, if the division deciding part decides that the un-extracted code is a divisible command code, the un-extracted code into a plurality of command codes,
wherein the command code extraction part extracts, from among the plurality of command codes obtained by the command code division part, a command code that is the same as the extraction target code, as a new extracted code.

7. The program editing device according to claim 1, comprising:
an extracting condition window display part to display an extracting condition window for specifying an extracting condition under which a command code is to be extracted from the target program,
wherein the command code extraction part extracts, from among the plurality of command codes included in the target program, a command code that satisfies the extracting condition specified on the extracting condition window, as a new extracted code.

8. A program editing method that uses a program editing device comprising an extraction target code storage part, a command code extraction part, a second program creating part, and a first program creating part,
the extraction target code storage part being a storage part to store, among a plurality of command codes included in a target program to be executed by a first execution part and a second execution part, a command code to be executed by the second execution part, as an extraction target code,
the program editing method including:
with the command code extraction part, extracting, from among the plurality of command codes included in the target program, a command code that is the same as the extraction target code stored in the extraction target code storage part, as an extracted code;
with the second program creating part, creating, as a second program to be executed by the second execution part, a program including the extracted code extracted by the command code extraction part; and
with the first program creating part, creating, as a first program to be executed by the first execution part, a program which is obtained by removing from the target program, the extracted code extracted by the command code extracting part.

9. A program editing program for causing a computer to function as the program editing device according to claim 1.
